(19) United States
(12) Patent Application Publication
(10) Pub. No.: US 2003/0019360 A1
(43) Pub. Date: Jan. 30, 2003

(54) Process and apparatus for separating foreign hydrogen halides from a stream of hydrogen chloride by means of absorption

(75) Inventors: Joerg Krissmann, Marl (DE); John Kahsnitz, Haltern (DE); Rudolf Burghardt, Recklinghausen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/179,957

(22) Filed: Jun. 26, 2002

(30) Foreign Application Priority Data
Jul. 26, 2001 (DE) 101 36 312.5

(51) Int. Cl. B01D 53/14

(52) U.S. Cl. 95/233

(57) ABSTRACT

Hydrogen chloride gas contaminated with foreign hydrogen halides may be purified by a process comprising selectively absorbing the foreign hydrogen halide in an absorption medium, preferably water or an aqueous hydrogen chloride solution. To minimize the mass flow of the foreign hydrogen halide loaded absorption medium which is discharged from the process, the absorption medium is preferably conveyed countercurrent to the gas in at least two coupled circuits in the absorber.

### BACKGROUND OF THE INVENTION

1. Field of the Invention

The invention relates to a process for separating small amounts of foreign hydrogen halides from a gaseous hydrogen chloride stream (HCl) by absorption, preferably using water or an aqueous solution of hydrogen chloride (hydrochloric acid) as the absorption medium.

2. Discussion of the Background

Many chemical processes are carried out using highly pure hydrogen chloride. An example is the preparation of highly pure silicon tetrachloride (SiCl₄) from hydrogen chloride and silicon. In this process, even the smallest traces of, for example, hydrogen bromide in the hydrogen chloride lead to significant contamination of the desired silicon tetrachloride product. The hydrogen chloride used in this process is generally obtained in gaseous form, and can contain appreciable amounts of, for example, hydrogen bromide as a result of the process by which it is prepared.

Processes employed industrially for purifying hydrogen chloride or hydrochloric acid from contamination by foreign halogens (i.e., halogens other than chlorine) are usually based on an electrolytic oxidation process, in which the halogen gas formed is driven from the solution (DE 43 20 865). A further method described in the literature comprises the oxidation of hydrogen bromide by the addition of pure chlorine (EP-A-0 506 050). Furthermore, European Patent Application EP-A-0 582 914 describes a process for concentrating dilute hydrochloric acid and separating off foreign halogens by means of a distillation carried out in a plurality of connected rectification columns.

All of the conventional purification processes use dilute aqueous hydrochloric acid as a starting material, and are carried out in the liquid phase. Thus, the impure hydrogen chloride gas must first be converted to an aqueous hydrochloric acid solution before any of the conventional purification processes can be used. The conversion of gaseous hydrogen chloride into an aqueous hydrochloric acid solution for the purpose of purification, and the subsequent conversion of the hydrochloric acid solution back into gaseous hydrogen chloride requires a considerable consumption of energy, and is therefore not economically feasible for a large-scale industrial process. In addition, all of the conventional processes require the use of a complicated apparatus in order to reduce the level of, for example, hydrogen bromide in the hydrogen chloride, down to a concentration of less than 1 ppm by weight.

### SUMMARY OF THE INVENTION

It is therefore an object of the invention to provide a process which allows small or trace amounts of foreign hydrogen halides to be separated directly from a gaseous hydrogen chloride stream. The concentration of the foreign hydrogen halide should be less than 1 ppm of foreign hydrogen halide in the hydrogen chloride gas stream.

Surprisingly, it has been found that the above described purification can be achieved by absorption of the foreign hydrogen halide from the hydrogen chloride gas stream, if the fresh absorption medium is preferably water or aqueous hydrochloric acid, and selectively retains at least one foreign halogen.

### BRIEF DESCRIPTION OF DRAWINGS

FIG. 1 is a diagram of an absorber for carrying out the process of the present invention.

FIG. 2 is a plot of the measured partition coefficient of HBr and the equilibrium mass fraction of HCl in the liquid phase at a pressure of 1 bar, as a function of the boiling temperature.

FIG. 3 is a plot of the mass fraction of HBr gas as a function of the number of stages in the absorber.

### DETAILED DESCRIPTION OF THE INVENTION

Thus, in a first embodiment, the process of the present selectively separates small amounts of foreign hydrogen halides from a gaseous hydrogen chloride stream by absorption, in an absorber preferably using water or aqueous hydrochloric acid as the fresh absorption medium. The absorption medium is preferably conveyed in countercurrent to the gas in at least two coupled circuits.

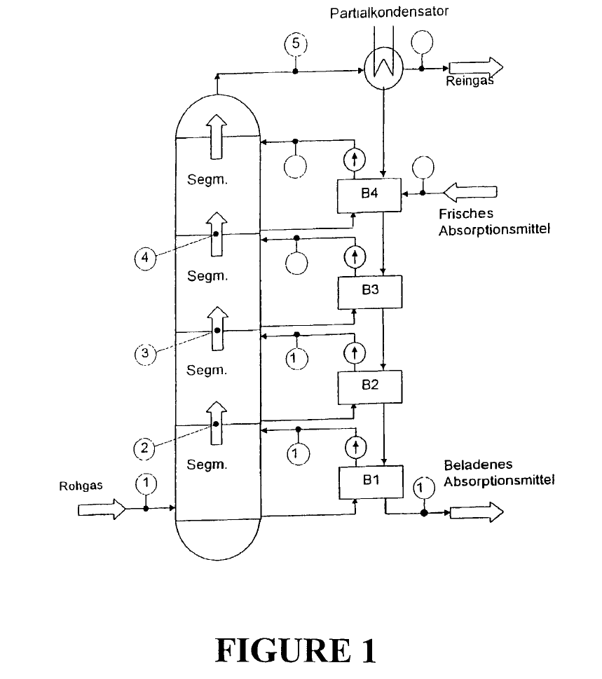

The absorber may comprise two or more segments which are preferably operated in a continuous countercurrent fashion. At the end of each segment, all of the liquid absorber phase is removed from the segment, while the gas continues on to the next segment in an upward direction. FIG. 1 shows, by way of example, an embodiment of an absorber for carrying out the process of the present invention, having four segments. However, the absorber in which the process of the present invention is carried out is not limited to four segments, but may have fewer or more segments, as required, to effect the desired level of purification of the hydrogen chloride gas. The pressure inside each segment may in the range from 0.1 bar to 20 bar absolute, preferably from 1 bar to 10 bar, particularly preferably about 1 bar (ambient pressure), inclusive of all values and subranges between 0.1 to 20 bar absolute. The temperature in each segment of the absorber may be in the range from 0° C. to 150° C., preferably in the range from 10° C. to 80° C., inclusive of all values and subranges between 0° C. to 150° C. The purified gas may be partially condensed. The partial condensation step, for economic reasons, preferably consists of one step. The temperature at which the partial condensation is carried out may be from −20° C. to +40° C., preferably below +5° C., particularly preferably below 0° C., and inclusive of all values and subranges between −20° C. to +40° C.

The concentration of the foreign hydrogen halide in the crude or impure feed gas may be in the range from 5 ppm by weight to 2000 ppm by weight, preferably in the range from 5 ppm by weight to 400 ppm by weight, inclusive of all values and subranges between 5 ppm by weight to 2000 ppm by weight. The gas stream may further comprise inert constituents, such as a nitrogen carrier gas. The concentration of the hydrogen chloride may therefore be in the range from 10% by volume to 100% by volume in the feed gas stream (calculated on a foreign hydrogen halide-free basis), preferably from 50% by volume to 100% by volume, particularly preferably from 90% by volume to 100% by volume, inclusive of all values and subranges between 10% to 100% by volume.

Table 1 describes mass flows and concentrations at the segments indicated, as calculated by a steady-state simulation using AspenPlus10.2™ for a selected example. Each segment was modeled as only one equilibrium stage. The composition model used was the electrolyte NRTL model, whose parameters have been validated on the basis of measured values for the phase equilibrium in the systems HCl/H₂O, HBr/H₂O and HBr/HCl/H₂O. In the model, the gaseous hydrogen chloride stream enters at the bottom of the absorber and passes through the absorber countercurrent to the absorption medium. As a result of contact with the water or the aqueous hydrochloric acid absorption medium, the thermodynamic equilibrium, which is influenced very significantly by the dissociation of the dissolved acids, is established in the theoretical separation stages. Owing to the position of the reactive phase equilibrium, chemisorption of hydrogen bromide also occurs in concentrated hydrochloric acid, which is formed by simultaneous absorption of hydrogen chloride into the water.

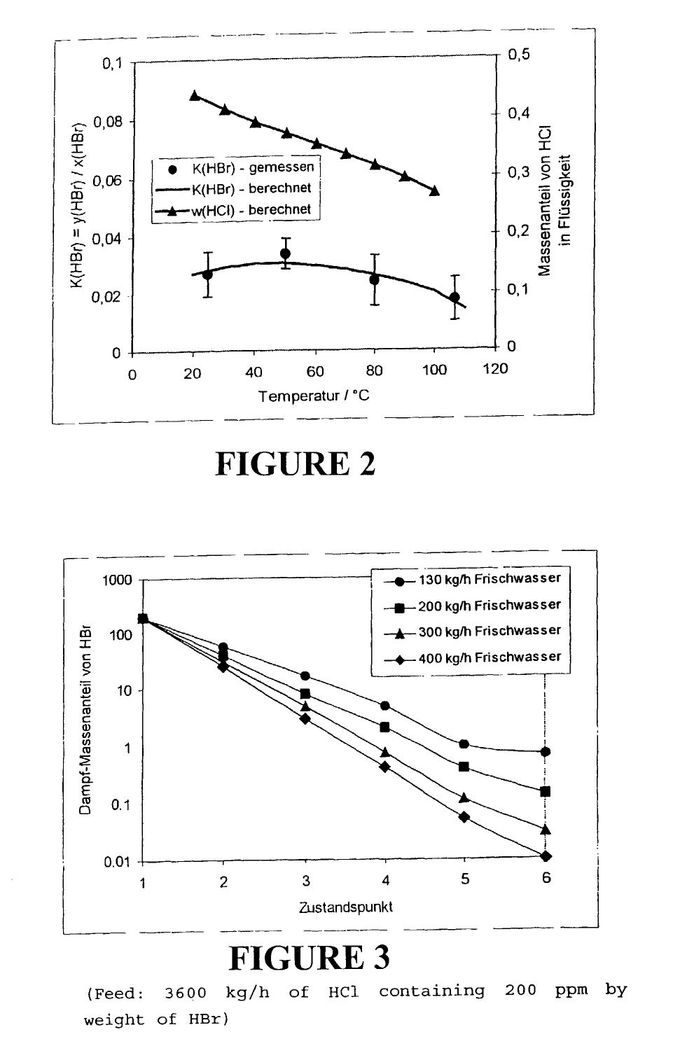

FIG. 2 shows the measured partition coefficient of HBr (which is equal to the mole fraction of HBr in the vapor phase divided by the mole fraction of HBr in the liquid phase) and the associated equilibrium mass fraction of HCl in the liquid phase, at a pressure of 1 bar, as a function of the boiling temperature. FIG. 2 shows that the partition coefficient of HBr is significantly smaller than one, even if the absorption medium is concentrated hydrochloric acid, and thus the selective removal of HBr from HCl is thermodynamically possible.

The mass flow of the hydrogen chloride discharged from the process in the loaded absorption medium is less than 20%, preferably less than 10%, particularly preferably less than 5%, of the total amount of hydrogen chloride introduced. To minimize the amount of contaminated absorption medium discharged and nevertheless ensure a sufficient trickle density, i.e. a sufficiently high ratio of liquid/gas (L/G ratio), the absorption medium is preferably conveyed to the bottom of the absorber in a plurality of separate circuits, as illustrated by FIG. 1.

The absorber can be subdivided into two or more segments having coupled absorption medium circuits. Each of the segments can comprise a plurality of theoretical separation stages. In the lowermost stage of each segment, all of the liquid phase is taken off, partly mixed with fresh absorption medium and subsequently returned to the top of the segment. The mass flow of the circulated absorption medium is kept constant. The proportion of the absorption medium taken off in the upper segment of a pair (for example, 3, as shown in FIG. 1) is added to the circuit of the segment underneath it (for example, 2, as shown in FIG. 1). In the uppermost segment, fresh absorption medium, here fresh water, is introduced. In the lowermost segment, a portion of the loaded absorption medium taken off is discharged from the process, and may be used for other purposes. Since the foreign hydrogen halide loading of the absorption medium decreases monotonically from the uppermost segment to the lowermost segment, very good purification with a relatively small loss of loaded absorption medium is achieved in the manner described. Overall, the gas (i.e., HCl) is preferably conveyed countercurrent to the liquid.

From Table 1, it can be seen that, for example, an initial hydrogen bromide loading of 200 ppm by weight in the gas stream is reduced to 6 ppm by weight after the gas stream passes through only two segments of the absorber apparatus. The loss of pure hydrogen chloride is only about 5% of the amount of hydrogen chloride introduced. The addition of further segments to the absorber allows further purification of the hydrogen chloride to even higher levels of purity to be achieved. After four segments, the vapor concentration of HBr is about 197 ppb by weight. The inclusion of a partial condenser at the top of the absorber apparatus provides a further purification of the hydrogen chloride to 59 ppb of HBr, with simultaneous drying of the gas stream. The condenser temperature in the example is −10° C. The concentration of water in the outflowing purified hydrogen chloride gas is 25 ppm by weight.

Thus, as described above, the process of the present invention can remove between 97% to 99.97% of the foreign hydrogen halides originally present in the unpurified hydrogen chloride gas stream. Of course, depending on the composition of the crude, unpurified gas stream, and the absorber configuration (i.e., number of segments, temperature, pressure, use of a partial condenser, etc.), different amounts of foreign hydrogen halides may be removed. For example, if the unpurified hydrogen halide gas stream initially contains low levels of foreign hydrogen halides, depending on the ultimate purity requirements, it may only be necessary to remove a relatively small amount, e.g., 50 to 75%, of the foreign hydrogen halides originally present. Conversely, if higher levels of foreign hydrogen halides are initially present in the unpurified hydrogen chloride gas stream, or if the hydrogen chloride must be extremely pure, it may be desirable to remove substantially higher amounts of the foreign hydrogen halide by the process of the present invention, for example, 95%, 96%, 97%, 98%, 99%, 99.9%, or 99.99% of the foreign hydrogen halide originally present. Alternatively stated, hydrogen chloride at varying levels of purity may be provided by the process of the present invention. For example, the concentration of purified hydrogen chloride gas removed from the absorber may be 90, 95, 96, 97, 98, 99, 99.9, 99.99, 99.999, 99.9999% or higher (volume %, based on the amount of hydrogen chloride and foreign hydrogen chloride), depending on how many segments are provided in the absorber, and whether or not the absorber also includes a condenser for partially condensing the purified hydrogen chloride gas before removal from the absorber.

In addition to the loading case simulated in Table 1, further parametric studies on the influence of variable amounts of absorption medium were carried out. The results are shown in FIG. 3. It can be seen that it is quite possible to achieve levels of HBr in the hydrogen chloride gas at the top of the absorber apparatus significantly below 1 ppm by weight by means of the process of the present invention. As a result of the circulation of the absorption medium, the discharge of hydrogen chloride from the process is very small, while the L/G ratio in the segments can be set at will.

TABLE 1
Results of steady-state simulation at 1 bar. The absorption
medium used was pure water (mass fraction of water = mass
fraction of HCl - mass fraction of HBr)

| | | | | Mass | Mass |
|---|---|---|---|---|---|
| | | | | fraction of | fraction of |
| | | | | HCl | HBr |
| | State of | Temperature | Mass flow | [% by | [ppm by |
| Position | matter | [° C.] | [kg/h] | weight] | weight] |
| 1 | Vap | 20 | 3600 | 99.98 | 200 |
| 2 | Vap | 22 | 3592.9 | 99.9 | 34 |
| 3 | Vap | 28.4 | 3579.7 | 99.8 | 6 |
| 4 | Vap | 37.5 | 3559.9 | 99.6 | 1 |
| 5 | Vap | 52.4 | 3510.7 | 98.7 | 0.197 |
| 6 | Vap | −10 | 3408.7 | 99.997 | 0.059 |
| 7 | Liq | 20 | 250 | 0 | 0 |
| 8 | Liq | 58.6 | 2000 | 33.9 | 9 |
| 9 | Liq | 41.9 | 2000 | 38.9 | 51 |
| 10 | Liq | 30.7 | 2000 | 41.5 | 282 |
| 11 | Liq | 23.6 | 2000 | 43.2 | 2000 |
| 12 | Liq | 23.6 | 441.3 | 43.2 | 2000 |

The priority document of the present application, German application 10136312.5, filed Jul. 12, 2001, is incorporated herein by reference.

Obviously, numerous modifications and variations on the present invention are possible in light of the above teachings. It is therefore to be understood that within the scope of the appended claims, the invention may be practiced otherwise than as specifically described herein.

What is claimed as new and is intended to be secured by letters patent is:

1. A process for purifying a crude gas comprising hydrogen chloride and at least one foreign hydrogen halide, comprising:
contacting said crude gas with an absorption medium in an absorber, wherein said absorption medium selectively absorbs at least one foreign hydrogen halide, thereby providing a loaded absorption medium comprising at least one foreign hydrogen halide and hydrogen chloride;
removing from the absorber a purified gas comprising hydrogen chloride; and
removing at least a portion of said loaded absorption medium from the absorber.

2. The process of claim 1, wherein the amount of hydrogen chloride removed from the absorber in the loaded absorption medium is less than 20% of the amount of hydrogen chloride introduced into the absorber in the crude gas.

3. The process of claim 1, wherein the amount of hydrogen chloride removed from the absorber in the loaded absorption medium is less than 10% of the amount of hydrogen chloride introduced into the absorber in the crude gas.

4. The process of claim 1, wherein the amount of hydrogen chloride removed from the absorber in the loaded absorption medium is less than 5% of the amount of hydrogen chloride introduced into the absorber in the crude gas.

5. The process of claim 1, wherein the absorber comprises at least two segments having coupled absorption medium circuits.

6. The process of claim 5, wherein the process is a continuous process, and the flow of absorber medium and crude gas in each segment are countercurrent.

7. The process of claim 1, wherein the purified gas is partially condensed at a temperature of −20° C. to +40° C. prior to removal from the absorber, thereby providing high purity, dry hydrogen chloride gas.

8. The process of claim 1, wherein the process is carried out at a temperature ranging from 0° C. to 150° C.

9. The process of claim 1, wherein the process is carried out at a temperature ranging from 10° C. to 80° C.

10. The process of claim 1, wherein the process is carried out at a pressure ranging from 0.1 bar to 20 bar absolute.

11. The process of claim 1, wherein the concentration of the hydrogen chloride in the crude gas stream is in the range of from 10% by volume to 100% by volume, calculated on a foreign hydrogen halide-free basis.

12. The process of claim 1, wherein the foreign hydrogen halide comprises hydrogen bromide.

13. The process of claim 12, wherein the concentration of hydrogen bromide in the crude gas is from 5 ppm by weight to 2000 ppm by weight.

14. The process of claim 12, wherein the concentration of hydrogen bromide in the crude gas is from 5 ppm by weight to 400 ppm by weight.

15. The process of claim 12, wherein the purified gas comprises less than 1 ppm by weight of hydrogen bromide.

16. The process of claim 1, wherein the absorption medium is water.

17. The process of claim 1, wherein the absorption medium is an aqueous hydrogen chloride solution.

18. A process comprising:
introducing a crude gas comprising hydrogen chloride gas and at least one foreign hydrogen halide into the bottom portion of a vertical absorber, wherein the absorber comprises an upper segment disposed above a lower segment, and optionally one or more additional segments disposed therebetween, each segment having means for circulating a liquid absorber medium countercurrent to the flow of the crude gas through the segment, and each means for circulating the liquid absorber medium is coupled to the segment immediately below;
contacting the crude gas with the liquid absorber medium, thereby selectively absorbing the at least one foreign hydrogen halide in the liquid absorber medium and providing a loaded absorber medium comprising the liquid absorber medium, at least one foreign hydrogen halide, and hydrogen chloride;
introducing fresh liquid absorber medium into the circulation means of the upper segment;
discharging a portion of the circulated loaded liquid absorber medium from each segment into the circulation means of the segment immediately below;
discharging from the absorber a portion of the circulated loaded liquid absorber medium from the lowest segment; and
removing a purified gas comprising hydrogen chloride from the upper portion of the absorber;
wherein the purified gas has a lower concentration of said at least one foreign hydrogen halide than the crude gas.

19. The process of claim 18, wherein the purified gas is partially condensed prior to said removing from the upper portion of the absorber.

20. The process of claim 18, wherein the process is carried out at a temperature ranging from 0° C. to 150° C.

21. The process of claim 18, wherein the process is carried out at a pressure ranging from 0.1 bar to 20 bar absolute.

22. The process of claim 18, wherein the concentration of the hydrogen chloride in the crude gas stream is in the range of from 10% by volume to 100% by volume, calculated on a foreign hydrogen halide-free basis.

23. The process of claim 18, wherein the foreign hydrogen halide comprises hydrogen bromide.

24. The process of claim 23, wherein the concentration of hydrogen bromide in the crude gas is from 5 ppm by weight to 2000 ppm by weight.

25. The process of claim 23, wherein the purified gas comprises less than 1 ppm by weight of hydrogen bromide.

26. The process of claim 18, wherein the absorption medium is water.

27. The process of claim 18, wherein the absorption medium is an aqueous hydrogen chloride solution.

28. An apparatus comprising:
a vertically oriented absorber comprising an upper segment disposed above a lower segment, and optionally one or more additional segments disposed therebetween, each segment having means for circulating a liquid absorber medium countercurrent to the flow of a crude gas through the segment, and each circulation means is coupled with the circulation means of the segment immediately below;
means for introducing a crude gas comprising hydrogen chloride gas and at least one foreign hydrogen halide into the bottom portion of the absorber;
means for introducing a fresh liquid absorber medium into the circulation means of the upper segment;
means for discharging a portion of the circulated liquid absorber medium from each segment into the circulation means of the segment immediately below;
means for discharging from the absorber a portion of the circulated liquid absorber medium from the lowest segment; and
means for removing a purified gas comprising hydrogen chloride from the upper portion of the absorber;
wherein the purified gas has a lower concentration of said at least one foreign hydrogen halide than the crude gas.

29. The apparatus of claim 28, further comprising a condenser connected to the means for discharging purified gas from the absorber, whereby the purified gas is partially condensed.
